(19) United States
(12) Patent Application Publication
(10) Pub. No.: US 2013/0228568 A1
(43) Pub. Date: Sep. 5, 2013

(54) MULTIPLE CHOKE SYSTEM FOR CONTAINING WIDE FREQUENCY BAND RF LEAKAGE

(71) Applicants: Trieu V. Huynh, Ooltewah, TN (US); Dale L. Price, Troy, OH (US); Kenneth A. Gratz, Tipp City, OH (US)

(72) Inventors: Trieu V. Huynh, Ooltewah, TN (US); Dale L. Price, Troy, OH (US); Kenneth A. Gratz, Tipp City, OH (US)

(73) Assignee: ILLINOIS TOOL WORKS INC., Glenview, IL (US)

(21) Appl. No.: 13/599,657

(22) Filed: Aug. 30, 2012

Related U.S. Application Data
(60) Provisional application No. 61/606,112, filed on Mar. 2, 2012.

(51) Int. Cl. H05B 6/46

(52) U.S. Cl. 219/774

(57) ABSTRACT

An oven may include a radio frequency (RF) source, a cooking chamber into which RF energy is providable via the RF source, and a door that is configured to hingedly operate to alternately allow access to the cooking chamber and close the cooking chamber for cooking The door may include a choke assembly disposed to seal a region between the door and a cooking chamber from RF leakage responsive to closure of the door. The choke assembly may include a plurality of tuned chokes, each of which is configured to shield relative to a different predefined frequency.

### CROSS REFERENCE TO RELATED APPLICATIONS

This application claims the benefit of U.S. Provisional Application No. 61/606,112, filed Mar. 2, 2012, the contents of each of which are incorporated herein in their entirety.

### TECHNICAL FIELD

Example embodiments generally relate to ovens and, more particularly, relate to provision of cookware appliances for an oven that is enabled to cook using radio frequency (RF).

### BACKGROUND

Combination ovens that are capable of cooking using more than one heating source (e.g., convection, steam, microwave, etc.) have been in use for decades. Each cooking source comes with its own distinct set of characteristics. Thus, a combination oven can typically leverage the advantages of each different cooking source to attempt to provide a cooking process that is improved in terms of time and/or quality.

Recently, ovens employing RF cooking as at least one mechanism by which a combination oven may cook food product have been developed. However, these ovens also have unique characteristics by virtue of the features made available in connection with the application of the heat sources involved. Such unique characteristics may create challenges relative to previously employed techniques and designs.

### BRIEF SUMMARY OF SOME EXAMPLES

Some example embodiments may provide an oven that employs multiple cooking sources, or at least a wide range frequency band RF energy source. Moreover, some example embodiments may further provide for the provision of a choke system that is capable of inhibiting or preventing RF leakage over a relatively broad range of frequencies.

In an example embodiment, an oven is provided. The oven may include a radio frequency (RF) source, a cooking chamber into which RF energy is providable via the RF source, and a door that is configured to hingedly operate to alternately allow access to the cooking chamber and close the cooking chamber for cooking. The door may include a choke assembly disposed to seal a region between the door and a cooking chamber from RF leakage responsive to closure of the door. The choke assembly may include a plurality of tuned chokes, each of which is configured to shield relative to a different predefined frequency.

In another alternative embodiment, a choke assembly is provided. The choke assembly may be for provision onto an oven door to seal radio frequency (RF) energy within the oven when the door is closed. The choke assembly may include a plurality of tuned chokes that are concentrically arranged adjacent to each other. Each tuned choke may be configured to shield relative to a different predefined frequency.

In another example embodiment, an oven may include a radio frequency (RF) source, a cooking chamber into which RF energy is providable via the RF source, and a door that is configured to hingedly operate to alternately allow access to the cooking chamber and close the cooking chamber for cooking. The door may include a at least a double choke disposed to seal a region between the door and a cooking chamber of the oven from RF leakage responsive to closure of the door. The at least double choke may include an outer tuned choke and an inner tuned choke, each of which is configured to shield relative to a same predefined frequency.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of an oven capable of employing at least two energy sources according to an example embodiment;

FIG. 2 illustrates a functional block diagram of the oven of FIG. 1 according to an example embodiment;

FIG. 3 illustrates a single tuned choke disposed around an RF screen that may be disposed in a window portion of a door;

FIG. 4 illustrates a perspective view of a choke assembly including two concentrically disposed chokes according to an example embodiment;

FIG. 5 illustrates a perspective view of a choke assembly including two concentrically disposed chokes according to an example embodiment;

FIG. 6, which includes FIGS. 6A and 6B, illustrates cross sectional views of a portion of the choke assembly of FIG. 5 according to an example embodiment;

FIG. 7 illustrates a perspective view of an internal corner portion of the door to illustrate the choke assembly according to an example embodiment;

FIG. 8 illustrates an external perspective view of a door according to an example embodiment;

FIG. 9 illustrates an internal perspective view of the door according to an example embodiment;

FIG. 10 illustrates a perspective view of a cross section of a choke assembly employing inner chokes associated with each respective tuned choke in accordance with an example embodiment; and

FIG. 11, which includes FIGS. 11A and 11B, illustrates another example embodiment of a tuned choke having a single frequency, double choke according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may improve the performance of an oven employing an example embodiment relative to inhibition or prevention of RF leakage. In this regard, since some example embodiments may implement RF cooking over a wide range of frequencies, a conventional RF choke that would be positioned around the door of the oven to prevent RF leakage may not be sufficient. Such chokes are typically tuned to a single frequency and thus, extensive leakage outside of the single frequency for which the choke was tuned would be expected. Example embodiments may therefore incorporate a multiple choke system so that the wide range of frequencies can be effectively contained.

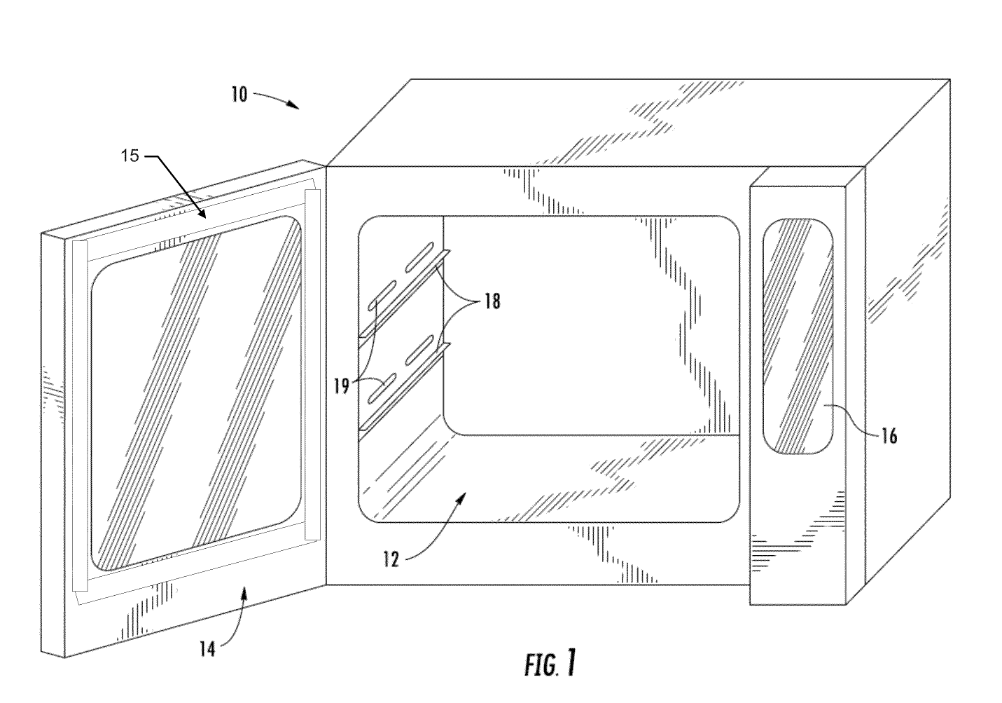

FIG. 1 illustrates a perspective view of an oven 10 according to an example embodiment. The oven 10 may be a heating device of any type for heating food products, thawing frozen materials and/or the like. Thus, the oven need not necessarily be embodied only as a combination oven or a microwave oven, but could alternatively be a thawing, warming, sterilizing or other device that applies RF energy. As shown in FIG. 1, the oven 10 may include a cooking chamber 12 into which a food product may be placed for the application of heat by any of at least two energy sources that may be employed by the oven 10. The cooking chamber 12 may include a door 14 and an interface panel 16, which may sit proximate to the door 14 when the door 14 is closed. In an example embodiment, the interface panel 16 may include a touch screen display capable of providing visual indications to an operator and further capable of receiving touch inputs from the operator. The interface panel 16 may be the mechanism by which instructions are provided to the operator, and the mechanism by which feedback is provided to the operator regarding cooking process status, options and/or the like.

In an example embodiment, the door 14 may be provided with a choke assembly 15 to prevent leakage of RF energy generated within the cooking chamber 12 to areas external to the oven 10. The choke assembly 15, which only conceptually shown in FIG. 1, may extend around a window portion of the door 12 to coincide with sidewalls and the top and bottom walls defining the cooking chamber 12. Thus, when the door 14 is closed, the walls of the cooking chamber 12, the window portion of the door 12 (if employed), and the choke assembly 15 may combine to contain RF energy and inhibit or prevent RF leakage. The choke assembly 15 will be described in greater detail below.

In some embodiments, the oven 10 may include multiple racks or may include rack (or pan) supports 18 or guide slots in order to facilitate the insertion of one or more racks or pans holding food product that is to be cooked. In an example embodiment, airflow slots 19 may be positioned proximate to the rack supports 18 (e.g., above the rack supports in one embodiment) to enable air to be forced over a surface of food product placed in a pan or rack associated with the corresponding rack supports 18. Food product placed on any one of the racks (or simply on a base of the cooking chamber 12 in embodiments where multiple racks are not employed) may be heated at least partially using radio frequency (RF) energy. Meanwhile, the airflow that may be provided may be heated to enable browning to be accomplished.

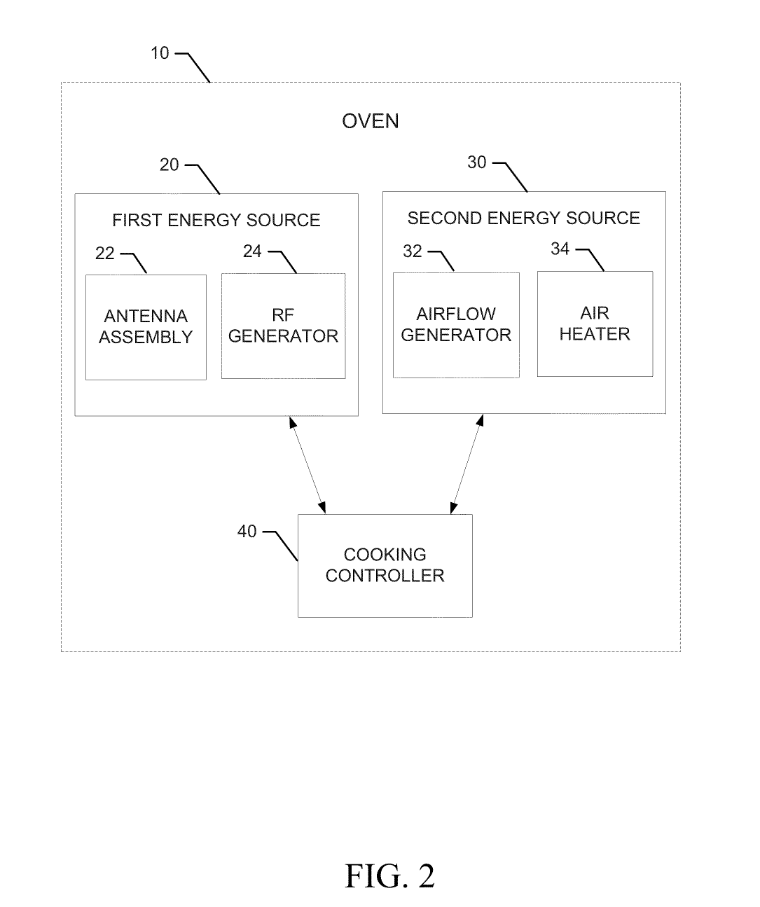

FIG. 2 illustrates a functional block diagram of the oven 10 according to an example embodiment. As shown in FIG. 2, the oven 10 may include at least a first energy source 20 and a second energy source 30. The first and second energy sources 20 and 30 may each correspond to respective different cooking methods. However, it should be appreciated that additional energy sources may also be provided in some embodiments.

In an example embodiment, the first energy source 20 may be an RF energy source configured to generate relatively broad spectrum RF energy to cook food product placed in the cooking chamber 12 of the oven 10. Thus, for example, the first energy source 20 may include an antenna assembly 22 and an RF generator 24. The RF generator 24 of one example embodiment may be configured to generate RF energy at selected levels over a range of about 800 MHz to about 1 GHz. The antenna assembly 22 may be configured to transmit the RF energy into the cooking chamber 12 and receive feedback to indicate absorption levels of respective different frequencies in the food product. The absorption levels may then be used, at least in part, to control the generation of RF energy to provide balanced cooking of the food product.

In some example embodiments, the second energy source 30 may be an energy source capable of inducing browning of the food product. Thus, for example, the second energy source 30 may include an airflow generator 32 and an air heater 34. However, in some cases, the second energy source 30 may be an infrared energy source, or some other energy source. In examples where the second energy source 30 includes the airflow generator 32, the airflow generator 32 may include a fan or other device capable of driving airflow through the cooking chamber 12 and over a surface of the food product (e.g., via the airflow slots). The air heater 34 may be an electrical heating element or other type of heater that heats air to be driven over the surface of the food product by the airflow generator 32. Both the temperature of the air and the speed of airflow will impact browning times that are achieved using the second energy source 30.

In an example embodiment, the first and second energy sources 20 and 30 may be controlled, either directly or indirectly, by a cooking controller 40. Moreover, it should be appreciated that either or both of the first and second energy sources 20 and 30 may be operated responsive to settings or control inputs that may be provided at the beginning, during or at the end of a program cooking cycle. Furthermore, energy delivered via either or both of the first and second energy sources 20 and 30 may be displayable via operation of the cooking controller 40. The cooking controller 40 may be configured to receive inputs descriptive of the food product and/or cooking conditions in order to provide instructions or controls to the first and second energy sources 20 and 30 to control the cooking process. The first energy source 20 may be said to provide primary heating of the food product, while the second energy source 30 provides secondary heating of the food product. However, it should be appreciated that the terms primary and secondary in this context do not necessarily provide any indication of the relative amounts of energy added by each source. Thus, for example, the secondary heating provided by the second energy source 30 may represent a larger total amount of energy than the primary heating provided by the first energy source 20. Thus, the term “primary” may indicate a temporal relationship and/or may be indicative of the fact that the first energy source is an energy source that can be directly measured, monitored and displayed. In some embodiments, the cooking controller 40 may be configured to receive both static and dynamic inputs regarding the food product and/or cooking conditions. Dynamic inputs may include feedback data regarding absorption of RF spectrum, as described above. In some cases, dynamic inputs may include adjustments made by the operator during the cooking process (e.g., to control the first energy source 20 or the second energy source 30), or changing (or changeable) cooking parameters that may be measured via a sensor network. The static inputs may include parameters that are input by the operator as initial conditions. For example, the static inputs may include a description of the food type, initial state or temperature, final desired state or temperature, a number and/or size of portions to be cooked, a location of the item to be cooked (e.g., when multiple trays or levels are employed), and/or the like.

In some embodiments, the cooking controller 40 may be configured to access data tables that define RF cooking parameters used to drive the RF generator 34 to generate RF energy at corresponding levels and/or frequencies for corresponding times determined by the data tables based on initial condition information descriptive of the food product. As such, the cooking controller 40 may be configured to employ RF cooking as a primary energy source for cooking the food product. However, other energy sources (e.g., secondary and tertiary or other energy sources) may also be employed in the cooking process. In some cases, programs or recipes may be provided to define the cooking parameters to be employed for each of multiple potential cooking stages that may be defined for the food product and the cooking controller 40 may be configured to access and/or execute the programs or recipes. In some embodiments, the cooking controller 40 may be configured to determine which program to execute based on inputs provided by the user. In an example embodiment, an input to the cooking controller 40 may also include browning instructions or other instructions that relate to the application of energy from a secondary energy source (e.g., the second energy source 30). In this regard, for example, the browning instructions may include instructions regarding the air speed, air temperature and/or time of application of a set air speed and temperature combination. The browning instructions may be provided via a user interface as described in greater detail below, or may be provided via instructions associated with a program or recipe. Furthermore, in some cases, initial browning instructions may be provided via a program or recipe, and the operator may make adjustments to the energy added by the second energy source 30 in order to adjust the amount of browning to be applied. In such a case, an example embodiment may employ the cooking controller 40 to account for changes made to the amount of energy to be added by the second energy source 30, by adjusting the amount of energy to be added via the first energy source 20.

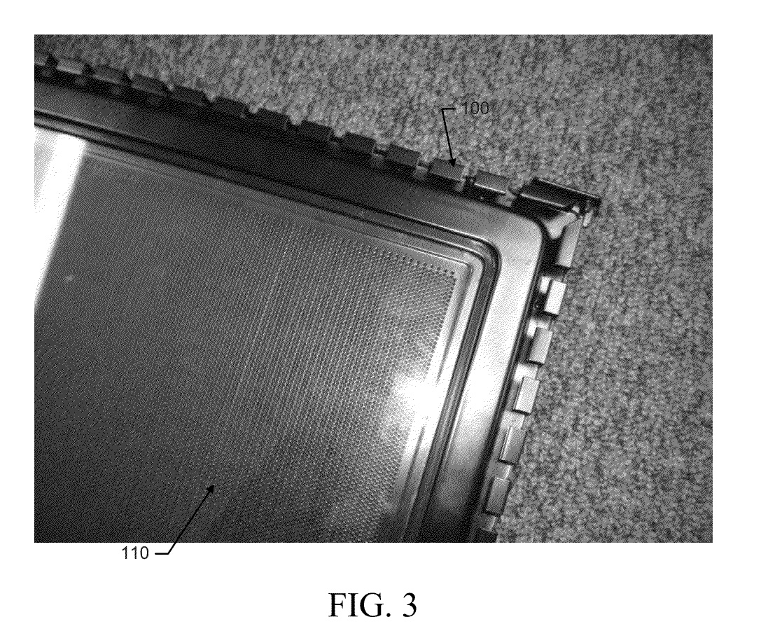

A choke configuration may typically include a single tuned choke configured to attenuate RF in a specific and relatively limited frequency range. FIG. 3 illustrates a single tuned choke 100 disposed around an RF screen 110 that may be disposed in a window portion of a door. In some situations, a choke configuration could be employed in connection with provision of the choke assembly 15 of FIG. 1 that was achieved by providing adjacent tuned chokes. In this regard, a first tuned choke and a second tuned choke may each be configured to block RF frequencies in specific bands that are determined based on the dimensions of the respective chokes. Thus, for example, the first tuned choke may be configured to block frequencies in the 800-900 MHz range and the second tuned choke may be configured to block frequencies in the 900 MHz to 1 GHz range. The first and second tuned chokes may be welded together, or may be co-extruded together using a single die. In some embodiments, the first and second tuned chokes may be made from an Aluminum extrusion process.

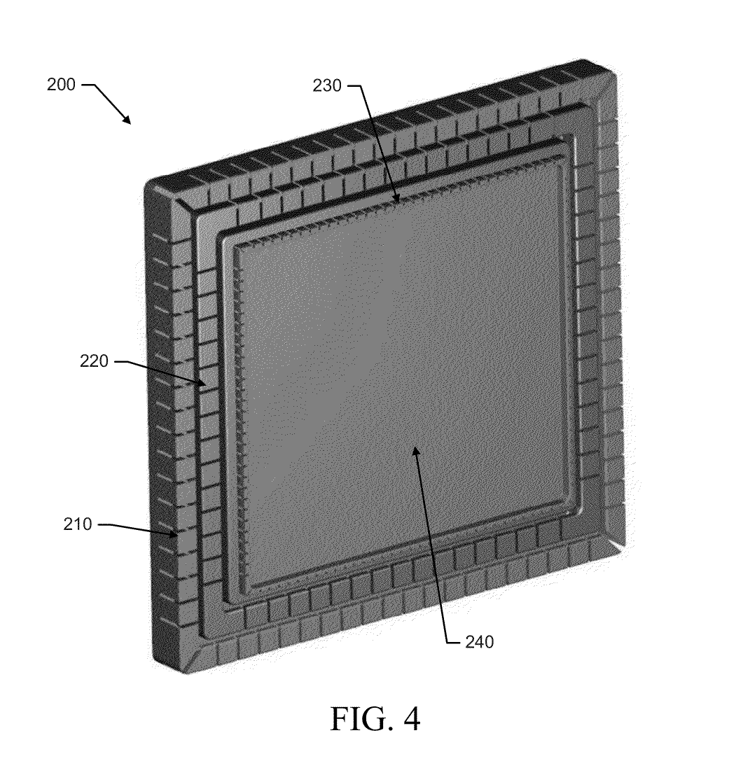

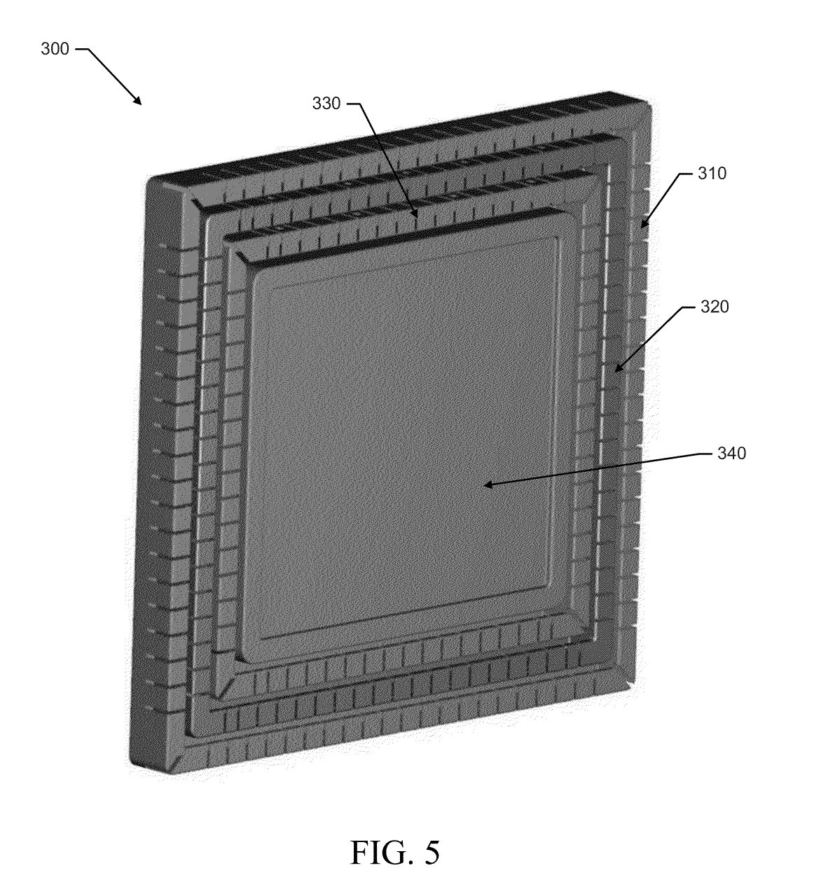

The choke stock may be extruded in any length and with any desirable tuning characteristics. The choke stock may then be cut and arranged to be disposed around a window portion of the door 14 to form the choke assembly 15 of FIG. 1. For example, a choke assembly may be formed by arranging cut pieces of the choke stock to define a window opening for the window portion of the door 14. The choke assembly may formed by welding together each portion of the choke stock. Thus, after cutting and arranging the choke stock, a plurality of precise welds would need to be formed between each discrete portion of choke stock that forms the choke (e.g., items 200 and 300 of FIGS. 4 and 5, respectively). Such welding may be difficult and/or expensive in some cases.

Accordingly, FIGS. 4 and 5 illustrate alternative embodiments of choke assemblies that may be utilized to form the choke assembly 15 of FIG. 1. However, it should be appreciated that in each of the example embodiments of FIGS. 4 and 5, the choke assemblies formed include a plurality of chokes that are tuned to different frequencies and arranged proximate to each other. Furthermore, in these examples, the proximately located chokes can be concentrically arranged around the window portion and around the entrance to the cooking chamber 12.

Referring now to FIG. 4, a choke assembly 200 is provided that may include a first tuned choke 210, a second tuned choke 220 and a metallic seal 230. The first and second tuned chokes 210 and 220 may each be formed structures that are generated from bending, or otherwise forming a metallic structure such that the resultant structure is tuned to attenuate a specific frequency or band of frequencies. For example, the first and second tuned chokes 210 and 220 may each be formed from sheet metal that is folded accordingly. The first tuned choke 210, which happens to be also the outer tuned choke, may be tuned to choke about 900 MHz to about 1 GHz. Meanwhile, the second tuned choke 220, which is also the inner choke, may be tuned to choke about 800 MHz to about 900 MHz. However, it should be appreciated that the inner and outer chokes could be reversed and other frequency ranges could be substituted.

In some embodiments, the first and second tuned chokes 210 and 220 may include a plurality of segmented portions having lengths and gaps therebetween that are selected to tune the corresponding chokes to seal relative to a corresponding selected wavelength of RF energy. In some embodiments, one or both of the chokes may have slots cut into the corner portions of the choke (e.g., see the first tuned choke 210). However, one or both of the chokes may instead have a corner portion without any slot provided therein (e.g., see the second tuned choke 220).

The first and second tuned chokes 210 and 220 may be disposed concentrically round the metallic seal 230 and the window portion 240. In an example embodiment, the metallic seal 230 may be spring loaded or otherwise extend slightly into the cooking chamber 12. In this regard, for example, the metallic seal 230 may include a plurality of metallic fingers that extend into the cooking chamber 12 to form a seal with the door 14 when the door 14 is closed. In an example embodiment, the first and second tuned chokes 210 and 220 may be covered by a high temperature plastic, Formica®, plastic laminate, resin material or other thin layer of material that actually contacts the face of the oven 10 proximate to the opening into the cooking chamber 12 when the door 14 is closed. In some cases, the allowable gap between the door 14 (i.e., the chokes) and the face of the oven when the door is closed may be less than about 1 mm.

FIG. 5 illustrates an alternative embodiment in which a choke assembly 300 is provided that includes a first tuned choke 310, a second tuned choke 320 and a third tuned choke 330. The first, second and third tuned chokes 310, 320 and 330 may each be formed structures that are generated from bending, or otherwise forming a metallic structure such that the resultant structure is tuned to attenuate a specific frequency or band of frequencies. For example, the first, second and third tuned chokes 310, 320 and 330 may each be formed from sheet metal that is folded accordingly. The first tuned choke 310, which happens to be also the outer tuned choke, may be tuned to choke about 1 GHz. Meanwhile, the second tuned choke 320, which is also the middle choke, may be tuned to choke about 900 MHz. The third tuned choke 330, which is the inner choke, may be tuned to choke about 800 MHz. However, it should be appreciated that the inner, middle and outer chokes could be rearranged in their orders and other frequency ranges could be substituted. According to this embodiment, leakage may be prevented over a desired frequency band (e.g., 800 to 1000 MHz) by providing a plurality of tuned chokes (e.g., three) with tuned center frequencies that are equidistantly spaced apart over the range of the desired frequency band. Thus, overall attenuation over the range of frequencies that are desired for shielding may be relatively strong.

In some embodiments, the first, second and third tuned chokes 310, 320 and 330 may include a plurality of segmented portions having lengths and gaps there between (e.g., to define fingerlike projections) that are selected to tune the corresponding chokes to seal relative to a corresponding selected wavelength of RF energy. In some embodiments, one, some or all of the chokes may have slots cut into the corner portions of the choke (e.g., see the first tuned choke 310 and the third tuned choke 330). However, one, some or all of the chokes may instead have a corner portion without any slot provided therein (e.g., see the second tuned choke 320). In some embodiments, chokes with and without slots cut in the corner portions may be alternated (as shown in FIG. 5).

The first, second and third tuned chokes 310, 320 and 330 may be disposed adjacent to one another concentrically round the window portion 340. In an example embodiment, the first, second and third tuned chokes 310, 320 and 330 may be covered by a plastic, Formica, or other thin layer of material that actually contacts the face of the oven 10 proximate to the opening into the cooking chamber 12 when the door 14 is closed. In some cases, the allowable gap between the door 14 (i.e., the chokes) and the face of the oven when the door is closed may be less than about 1 mm.

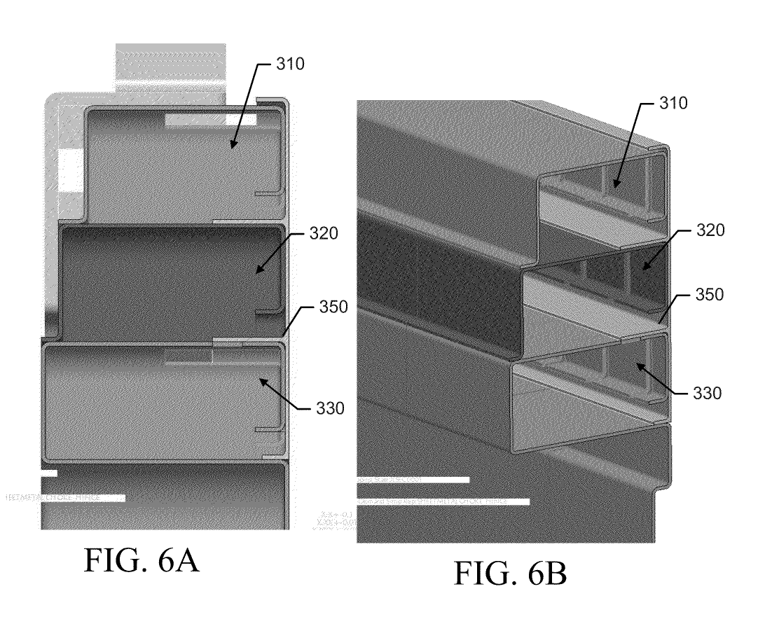

In some embodiments, the first, second and third tuned chokes 310, 320 and 330 may be attached to one another via a welding process or any other suitable joining mechanism. FIG. 6, which includes FIGS. 6A and 6B, illustrates cross sectional views of a portion of the choke assembly 300 of FIG. 5. In this regard, FIG. 6A illustrates a side view of the cross section of the choke assembly 300 and FIG. 6B illustrates a perspective view of the cross section of the choke assembly 300. As can be seen in FIG. 6, the size of each choke assembly 300 may be different. While the tuned chokes may be arranged such that the largest sized chokes are internally disposed and smaller sized chokes are on the outside, it should be appreciated that some designs may depart from that arrangement and institute an opposite ordering or even an ordering that is not dependent upon size. Each of the chokes of the choke assembly 300 may be configured to define a cavity that is tuned to reject or reflect a corresponding nominal frequency (e.g., 800 MHz, 900 MHz and 1000 MHz) based on arranging the corresponding conductive path lengths to be less than or equal to ¼λ where λ is wavelength of the nominal frequency in question. Thus, for example, the shortest cavity wall (i.e., the wall tuned to 1000 MHz) may include three component walls that measure 40 mm, 20 mm and 15 mm, respectively, for a total conductive path length of 75 mm. The speed of light is about 3.0×10⁸ m/s, so the quarter wavelength at 1000 MHz is about 75 mm. Similar calculations may be used to provide the total conductive path lengths to be used for the larger cavities of the 900 MHz and 800 MHz chokes.

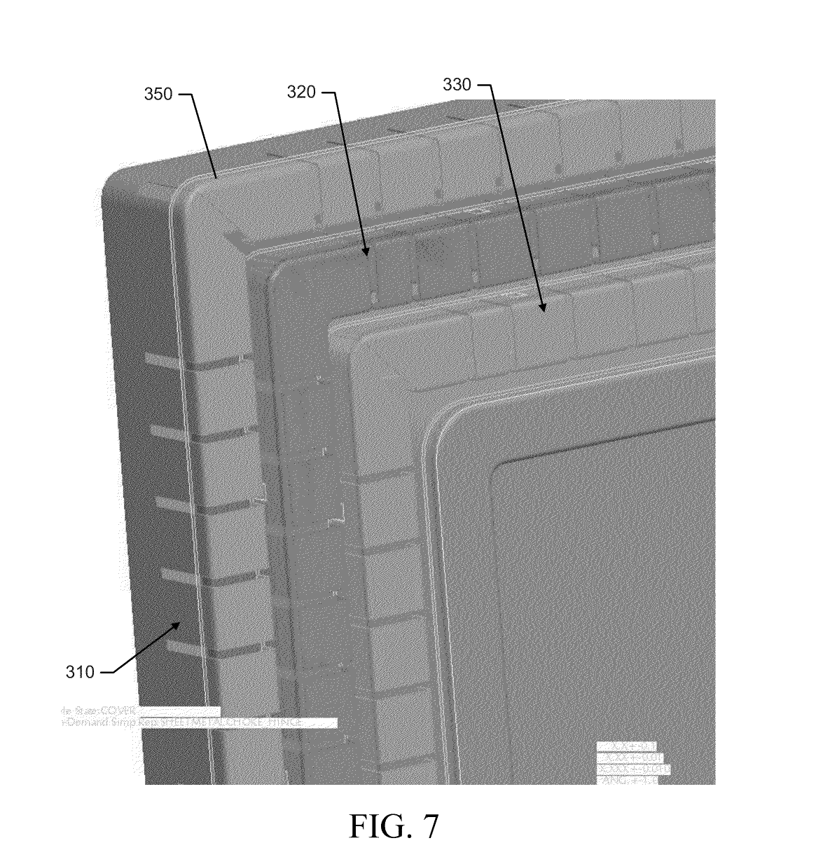

FIG. 6 also illustrates a layer of material forming a cover 350 that may be easy to clean and maintain, while still providing for a relatively small gap between the choke assembly 300 and the face of the oven 10 when the door 14 is closed. The cover 350 may be made of high temperature plastic, Formica®, plastic laminate, resin material or other thin layer of material that is relatively smooth and easy to clean. As shown in FIG. 6, the side of the door that faces the oven may be constructed such that each of the tuned chokes is aligned so that when the cover 350 is applied, a smooth face is presented to provide a relatively tight fit with the face of the oven 10 when the door is closed. As such, the uneven portions of the tuned chokes may be outwardly disposed and an external door covering, or door frame may be provided to give an aesthetically pleasing view of the door 14 from the outside. FIG. 7 illustrates a perspective view of an internal corner portion of the door to illustrate the choke assembly 300 and the alternating disposal of tuned chokes having corner slots as described above. FIG. 7 also shows how the interior faces of the tuned chokes may be aligned so that the cover 350 may be applied to provide a smooth surface for cleaning and providing a tight fit with a face of the oven 10.

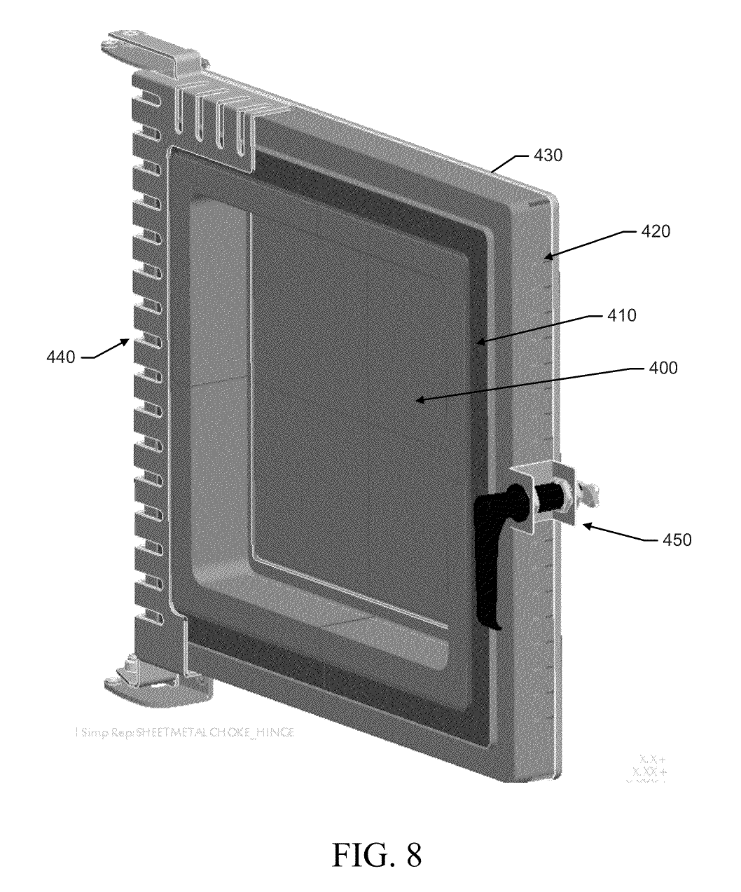

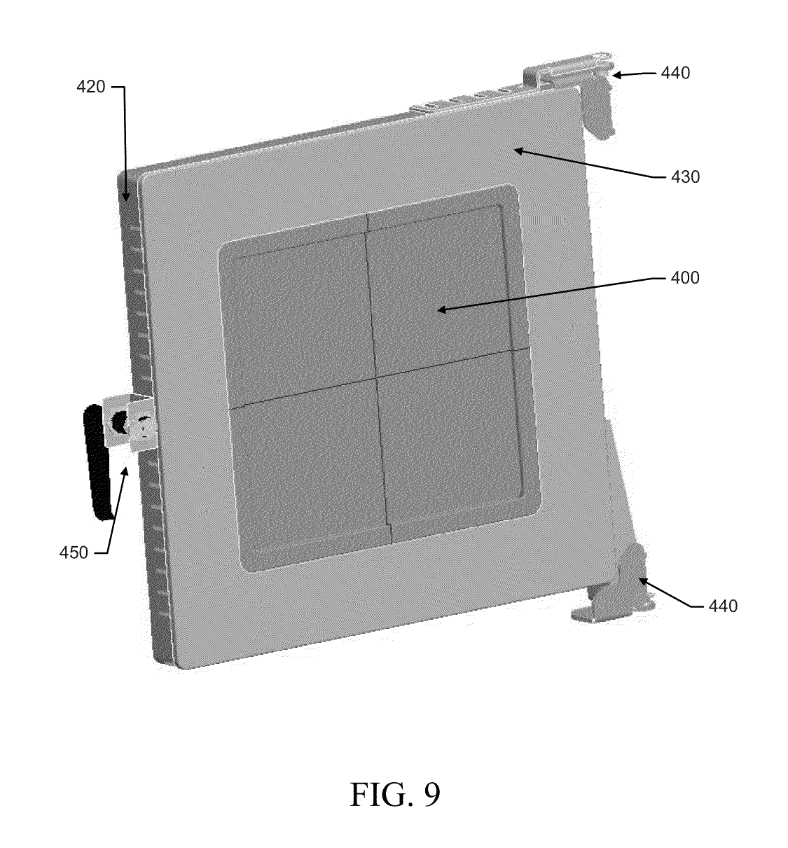

FIG. 8 illustrates an external perspective view of a door according to an example embodiment. Meanwhile, FIG. 9 illustrates an internal perspective view of the door. As can be seen in FIGS. 8 and 9, the door includes a window portion 400 surrounded by a door frame 410. The outer choke 420 is then shown on a back portion of the door 14. The window portion 400 may include glass, RF screens, combinations thereof, or other screening mechanisms. The outer choke 420 is covered by the cover 430. The door may be mounted on a hinge assembly 440 and may include a latch assembly 450 to enable opening and closing of the door in addition to latching of the door when the door is closed.

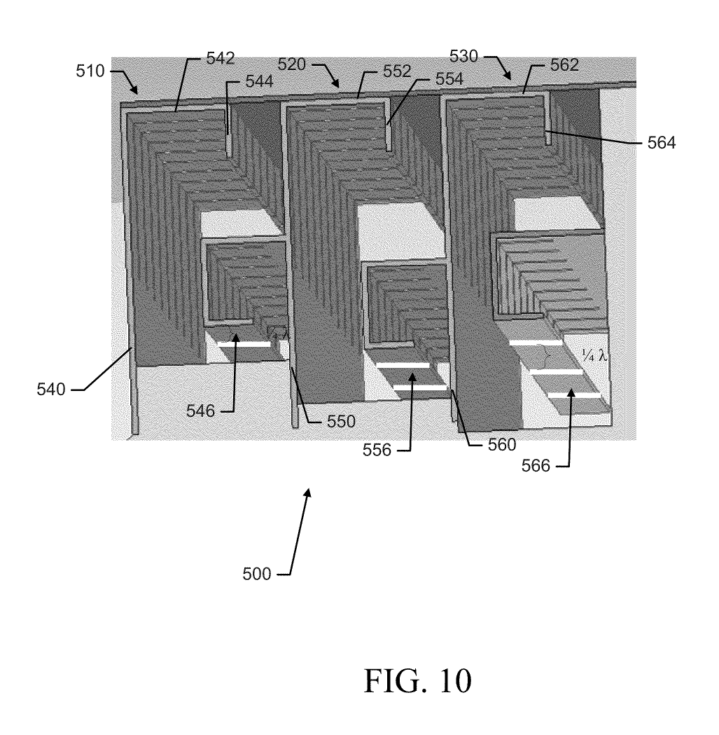

Although some example embodiments may be tuned only to center frequencies of 800 MHz, 900 MHz and 1000 MHz in order to provide attenuation in the range from about 800 MHz to 1000 MHz, it may be possible to further configure some embodiments to include partial chokes that are defined as inner chokes within the other tuned chokes. FIG. 10 illustrates an example embodiment of a choke assembly 500 including first, second and third tuned chokes 510, 520 and 530 that may be disposed proximate to each other to prevent RF energy leakage from an oven door over the range of about 800 MHz to about 1000 MHz. In some cases, the first, second and third tuned chokes 510, 520 and 530 may be affixed to one another via a welding process, may be co-extruded or may be joined via any other suitable joining mechanism. FIG. 10 illustrates a cross sectional view of a portion of the choke assembly 500 of FIG. 10. However, it should be appreciated that the first, second and third tuned chokes 510, 520 and 530 may extend around a window portion of an oven door to coincide with sidewalls and the top and bottom walls defining the cooking chamber of the oven. Thus, when the door is closed, the walls of the cooking chamber, any window portion of the door (if employed), and the choke assembly 500 may combine to contain RF energy and inhibit or prevent RF leakage from the oven.

The first, second and third tuned chokes 510, 520 and 530 may be concentrically arranged such that each of the first, second and third tuned chokes 510, 520 and 530 lie substantially in a same plane (e.g., a plane substantially parallel to a plane in which the door lies). The first, second and third tuned chokes 510, 520 and 530 could be provided concentrically in any order. Thus, for example, the tuned choke having the largest conductive path length could be the largest concentrically arranged tuned choke (i.e., having the largest perimeter length), or could be the smallest concentrically arranged tuned choke (i.e., having the smallest perimeter length), or could be in between the other tuned chokes.

As shown in FIG. 10, the first tuned choke 510 may include a first primary choke portion (defined by a first wall 540, a second wall 542 and a third wall 544) and a first inner choke portion 546. The first inner choke portion 546 may further include at least three component walls that define portions of the conductive path length of the first inner choke 546. As shown in FIG. 10, the second tuned choke 520 may include a second primary choke portion (defined by a first wall 550, a second wall 552 and a third wall 554) and a second inner choke 556. Similar to the first tuned choke 510, the second inner choke 556 of the second tuned choke 520 may also include at least three component walls that define portions of the conductive path length of the second inner choke 556. Likewise, the third tuned choke 530 may include a third primary choke portion (defined by a first wall 560, a second wall 562 and a third wall 564) and a third inner choke 566. Similar to the first and second tuned chokes 510 and 520, the third inner choke 566 of the third tuned choke 530 may also include at least three component walls that define portions of the conductive path length of the third inner choke 566.

In an example embodiment, the first walls 540, 550 and 560 of each of the first, second and third tuned chokes 510, 520 and 530 may have lengths that are wavelength dependent. Similarly, the second walls 542, 552 and 562 of the first, second and third tuned chokes 510, 520 and 530 may also be substantially the same length (although the length of the second walls may be different than the lengths of the first walls). The third walls 544, 554 and 564 of each of the first, second and third tuned chokes 510, 520 and 530 may also be substantially the same length (although the length may be different than that of the first walls and/or second walls). Thus, tuning differences between the first, second and third tuned chokes 510, 520 and 530 may be provided based on the placement and/or path lengths defined by the respective inner chokes (e.g., the first inner choke 546, the second inner choke 556 and the third inner choke 566). In some embodiments, the first, second and third inner chokes 546, 556 and 566 may be formed of consecutively arranged “fingers” that extend parallel to one another. In other words, there may be slots or relatively small spaces formed between each of the fingers (similar to the slots formed between fingers of the walls of the first, second and third tuned chokes 510, 520, 530). In an example embodiment, each of the fingers may have a length of less than or equal to a quarter wavelength relative to the tuned frequency for each respective choke.

In the example shown in FIG. 10, the first inner choke 546 may extend away from the first wall 550 of the second tuned choke 520 toward the first wall 540 of the first tuned choke 510. The second inner choke 556 may extend away from the first wall 560 of the third tuned choke 530 toward the first wall 550 of the second tuned choke 520. The third inner choke 566 may extend toward the first wall 560 of the third tuned choke. The secondary choke geometries defined by the inclusion of the inner chokes (546, 556 and 566) within each primary choke to define the first, second and third tuned chokes 510, 520 and 530 may be selected to also meet the quarter wavelength criteria mentioned above. However, for the same frequency range (e.g., 800 MHz to 1000 MHz), some example embodiments have shown an increase in the attenuation provided relative to embodiments that do not employ the inner chokes.

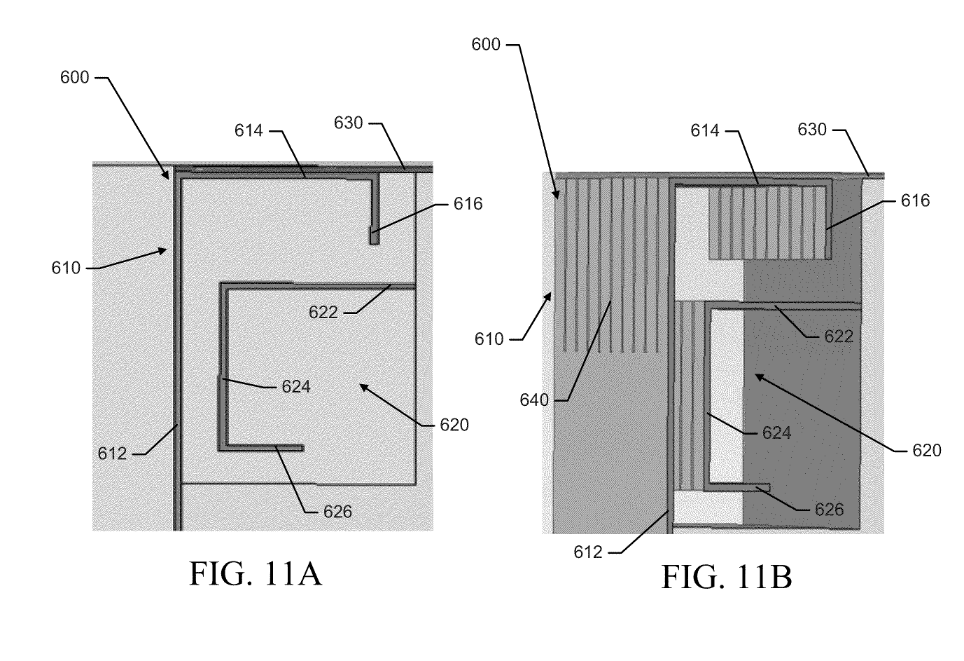

Although FIG. 10 shows multiple adjacently disposed tuned chokes with each tuned choke having a respective inner choke, it should be appreciated that a multiple layer choke could alternatively be provided to be tuned to a single frequency rather than to multiple different frequencies. FIG. 11, which includes FIGS. 11A and 11B, illustrates another example embodiment of a tuned choke having a single frequency, double choke according to an example embodiment. In this regard, FIG. 11A illustrates a cross section view of a portion of a double choke 600. The double choke 600 includes an outer tuned choke 610 and an inner tuned choke 620. The outer tuned choke 610 and the inner tuned choke 620 may each be tuned to the same frequency. In one example embodiment, the outer tuned choke 610 and the inner tuned choke 620 may each be tuned to a frequency of about 915 MHz+/−13 MHz. However, the double choke 600 may further assist in preventing leakage responsive to phase changes made at the tuned frequency.

As shown in FIG. 11, the outer tuned choke 610 may include a first wall 612, a second wall 614 and a third wall 616. Meanwhile, the inner tuned choke 620 may include a first wall 622, a second wall 624 and a third wall 626. Lengths of the first, second and third walls of each of the first and second tuned chokes 610 and 620 may be selected to be less than or equal to a quarter wavelength relative to the tuned frequency of the double choke 600.

In an example embodiment, the first wall 612 of the outer tuned choke 610 may extend substantially perpendicular to a cover 630 (e.g., similar to cover 350) that may define a portion of the door that meets up with the oven and extends around the front opening of the oven that is sealed by the double choke 600 to prevent leakage of RF energy out of the oven. The second wall 614 of the outer tuned choke 610 may extend adjacent and substantially parallel to the cover 630. The third wall 616 of the outer tuned choke 610 may extend substantially perpendicular to the second wall 614 and substantially parallel to the first wall 612. As such, for example, the first wall 612 and the third wall 616 may extend parallel to each other from opposite ends of the second wall 614.

In an example embodiment, the first wall 622 of the inner tuned choke 620 may extend substantially perpendicular to the second wall 624 of the inner tuned choke 620. Meanwhile, the second wall 624 of the inner tuned choke 620 may extend substantially parallel to the first wall 612 of the outer tuned choke 610. The first wall 622 of the inner tuned choke 620 may also extend substantially parallel to the second wall 614 of the outer tuned choke 610. The third wall 626 of the inner tuned choke 620 may extend substantially perpendicular to the second wall 624 and substantially parallel to the first wall 622. As such, for example, the first wall 622 and the third wall 626 may extend parallel to each other from opposite ends of the second wall 624. In an example embodiment, the third wall 616 of the outer tuned choke 610 may extend toward the first wall 622 of the inner tuned choke 620. Meanwhile, the third wall 626 of the inner tuned choke 620 may extend away from the first wall 612 of the outer tuned choke 610.

In some embodiment, slots 640 may be formed between fingers of the inner and outer tuned chokes 610 and 620 as described above. The inner tuned choke 620 may be proximate to a window in the door, while the outer tuned choke 610 extends around a periphery of the door. Thus, the inner tuned choke 620 may be “inwardly” disposed relative to the periphery of the door. However, the inner tuned choke 620 may also be considered to be an “inner” choke based on the fact that the second and third walls 624 and 626 of the inner tuned choke 620 may be disposed to fit substantially within the length and width dimensions defined by the walls of the outer tuned choke 610. As such, the inner tuned choke 620 may appear to be disposed within the outer tuned choke 610.

Example embodiments may provide a multiple layer choke system instead of a single choke and may therefore provide an ability to provide coverage over a wider range of frequencies instead of over just a single frequency. Some example embodiments may also provide a choke system that has a reduced fabrication cost while still providing a robust attenuation capability relative to welded structures.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An oven comprising:
a radio frequency (RF) source;
a cooking chamber into which RF energy is providable via the RF source; and
a door configured to hingedly operate to alternately allow access to the cooking chamber and close the cooking chamber for cooking,
wherein the door comprises a choke assembly disposed to seal a region between the door and a cooking chamber from RF leakage responsive to closure of the door, the choke assembly including a plurality of tuned chokes, each of which is configured to shield relative to a different predefined frequency.

2. The oven of claim 1, wherein the tuned chokes are concentrically arranged adjacent to each other.

3. The oven of claim 2, wherein the concentrically arranged, tuned chokes each lie substantially in a same plane that lies parallel to a plane in which the door lies.

4. The oven of claim 2, wherein the concentrically arranged, tuned chokes are disposed around an RF screen disposed in a window portion of the door.

5. The oven of claim 1, wherein the tuned chokes include a first tuned choke configured to attenuate frequencies between about 800-900 MHz and a second tuned choke configured to attenuate frequencies between about 900-1000 MHz.

6. The oven of claim 1, wherein the tuned chokes include a first tuned choke configured to attenuate frequencies centered around about 800 MHz, a second tuned choke configured to attenuate frequencies centered around about 900 MHz, and a third tuned choke configured to attenuate frequencies centered around about 1 GHz.

7. The oven of claim 1, wherein the tuned chokes are welded together or co-extruded.

8. The oven of claim 1, wherein each of the tuned chokes comprises a first wall, a second wall extending substantially perpendicular to the first wall, and a third wall extending substantially perpendicular to the second wall and substantially parallel to the first wall, and wherein the first walls of each of the tuned chokes lie in planes that are substantially parallel to each other.

9. The oven of claim 8, wherein each wall of at least one of the tuned chokes is formed of a plurality of fingers consecutively arranged parallel to one another.

10. The oven of claim 8, wherein a sum of lengths of the first, second and third walls of each respective tuned choke is less than or equal to about a quarter wavelength of a frequency that each respective choke is configured to attenuate.

11. The oven of claim 8, wherein at least one of the tuned chokes comprises an inner choke.

12. The oven of claim 11, wherein respective sums of lengths of the first, second and third walls of each respective tuned choke are equal, and the sums of the lengths of the inner chokes of each respective tuned choke is less than or equal to about a quarter wavelength of a frequency that each respective choke is configured to attenuate.

13. The oven of claim 8, wherein one of the first walls, the second walls or the third walls of each of the tuned chokes lie in a same plane proximate to a cover that faces the oven when the door is shut.

14. A choke assembly for provision onto an oven door to seal radio frequency (RF) energy within the oven when the door is closed, the choke assembly comprising:
a plurality of tuned chokes that are concentrically arranged adjacent to each other, each tuned choke being configured to shield relative to a different predefined frequency.

15. The choke assembly of claim 14, wherein the concentrically arranged, tuned chokes each lie substantially in a same plane that lies parallel to a plane in which the door lies.

16. The choke assembly of claim 14, wherein the tuned chokes include a first tuned choke configured to attenuate frequencies between about 800-900 MHz and a second tuned choke configured to attenuate frequencies between about 900-1000 MHz.

17. The choke assembly of claim 14, wherein the tuned chokes include a first tuned choke configured to attenuate frequencies centered at about 800 MHz, a second tuned choke configured to attenuate frequencies centered at about 900 MHz, and a third tuned choke configured to attenuate frequencies centered at about 1 GHz.

18. The choke assembly of claim 14, wherein the tuned chokes are welded together or co-extruded.

19. The choke assembly of claim 14, wherein each of the tuned chokes comprises a first wall, a second wall extending substantially perpendicular to the first wall, and a third wall extending substantially perpendicular to the second wall and substantially parallel to the first wall, and wherein the first walls of each of the tuned chokes lie in planes that are substantially parallel to each other.

20. The choke assembly of claim 19, wherein at least one of the tuned chokes comprises an inner choke.

21. An oven comprising:
a radio frequency (RF) source;
a cooking chamber into which RF energy is providable via the RF source; and
a door configured to hingedly operate to alternately allow access to the cooking chamber and close the cooking chamber for cooking,
wherein the door comprises at least a double choke disposed to seal a region between the door and a cooking chamber from RF leakage responsive to closure of the door, the at least double choke including an outer tuned choke and an inner tuned choke, each of which is configured to shield relative to a same predefined frequency.

22. The oven of claim 21, wherein the outer and inner tuned chokes are concentrically arranged adjacent to each other.

23. The oven of claim 21, wherein the outer and inner tuned chokes are configured to attenuate frequencies of about 915 MHz.

24. The oven of claim 21, wherein the outer tuned choke and the inner tuned choke each comprise respective first walls, second walls extending substantially perpendicular to the first walls, and third walls extending substantially perpendicular to their respective second walls and substantially parallel to their respective first walls.
